(19) United States
(12) Patent Application Publication
(10) Pub. No.: US 2006/0083480 A1
(43) Pub. Date: Apr. 20, 2006

(54) Video recording and playback apparatus and video playback method utilizing the apparatus for enabling direct examination of selected linkage positions between successive cuts that constitute edited video contents

(76) Inventors: Akira Nakamura, Yokosuka-shi (JP); Masaru Moritake, Yokohama (JP)

Correspondence Address: CLARK & BRODY, 1090 VERMONT AVENUE, NW, SUITE 250, WASHINGTON, DC, 20005, US

(21) Appl. No.: 11/249,413

(22) Filed: Oct. 14, 2005

(30) Foreign Application Priority Data
Oct. 15, 2004 (JP) 2004-302278

(51) Int. Cl. H04N 5/76; G11B 27/00

(52) U.S. Cl. 386/52; 386/55

(57) ABSTRACT

An apparatus stores a plurality of video cuts successively linked by playlist information, and corresponding thumbnails. A plurality of the thumbnails can be displayed successively arrayed, with an intermediate image defined between each adjacent pair. When a GUI is operated to select an intermediate image and a playback operation is then initiated, a predetermined terminating portion of the cut corresponding to the thumbnail immediately preceding the selected intermediate image and a predetermined initial portion of the cut corresponding to the thumbnail immediately following the intermediate image are played back consecutively, enabling the transition between these two cuts to be visually examined.

### BACKGROUND OF THE INVENTION

1. Field of Application

The present invention relates to a video recording and playback apparatus which enables visual examination of linkage positions between video cuts that have been successively linked by video editing using editing point information, and to a video playback method which utilizes the video recording and playback apparatus.

2. Description of Prior Art

Types of video recording and playback apparatus are utilized in the prior art which can be operated to perform a form of video editing for linking successive video cuts (where each cut is a continuous sequence of video frames, derived from an original video signal), but whereby storage locations of the video data are not modified by the editing processing. Instead, during playback of the edited video data, “editing points” are utilized, which specify the respective locations of the start and end points of specific cuts, within the stored video data, as points at which cuts are to be joined. The start of each successive cut within the edited video data is obtained during playback, based on the editing point information, so that the edited video data can be played back in a required sequence, with the same effect being obtained as if the respective cuts had actually been successively spliced together. Such a function is referred to as a “playlist” function, with a set of editing points constituting a playlist, and is utilized with a video recording and playback apparatus that stores data in a random access type of storage medium such as video recording disks or a random access memory (RAM).

An example of such an editing method is described in Japanese patent publication No. 2004-140750, referred to in the following as reference 1. Such a playlist method does not utilize video data that are played back as a single set of data, so that the editing results can be reproduced by using the playlist and modified by modifying the playlist contents. That is to say, the playlist can be used to designate specific items (i.e., cuts) in the stored video data, and to designate the sequence in which the selected items are to be played back to constitute the edited video data.

If such a playlist is available, then it is possible to examine the linkage positions between successive video cuts in the edited data i.e., the positions at which each cut is to be joined to the succeeding video cut, in the sequence of the edited video data. However the methods of setting the editing points, and of arranging the sequence of video cuts, vary between different types of video editing apparatus. With a certain type of video editing apparatus referred to in the following as the type 1 apparatus, as shown in FIG. 8, each editing point may be expressed as a value of elapsed time along a timeline that begins at the start of playback of a set of stored video data (for example, the start of playback of the first track of a video recording disk). In that case, the editing point information is displayed to a user in the form of a text list.

In the example of FIG. 8, a video cut (referred to in the following simply as a “cut”) #001 has a starting point at the timeline position 00:00:01:12 and ends at the position 00:00:05:23.

In general, each cut is stored in conjunction with a single-picture “thumbnail” image, referred to in the following description simply as a thumbnail, that is indicative of the contents of the corresponding cut. With another type of video editing apparatus referred to in the following as the type 2 apparatus, as illustrated in FIG. 9, the editing point information is displayed to a user as a plurality of regions respectively sequentially arrayed (e.g., horizontally) in conjunction with a display of the playback timeline. Each of these display regions corresponds contains a corresponding thumbnail, and the start and end points of each display region correspond to the editing start point and editing end point of the corresponding cut. In addition, the user can employ a graphical user interface (GUI) function to adjust the position of a marker 900, which designates the point (in the edited video data) at which playback will begin, the next time that playback of the edited video data is initiated (e.g., by actuation of a specific switch, dedicated for this type of playback).

The user can set the marker 900 at a position that immediately precedes a specific linkage position that is a transition from one cut (such as the cut corresponding to the region #002 in FIG. 9) to the succeeding cut (corresponding to the region #003 in FIG. 9). In that way, the user can thereafter repetitively perform playback of the edited video data, starting from a point immediately prior to the specified linkage position, and so can visually examine the linkage position.

With the type 1 apparatus, the editing point information is expressed in the form of numerals, with one set of numerals expressing one cut. Hence in order to enable examining of the linkage positions between successive cuts in the edited video data, respective serial numbers are assigned to the cuts. For example as shown in FIG. 10, the serial number 1000 may be assigned to one of the cuts, while as shown in FIG. 11 the serial number 1100 may be assigned to another cut, thereby ensuring that these two cuts will be played back successively.

With the type 2 apparatus, a marker such as the marker 900 indicates an editing point which occurs immediately before the point at which playback of cut #003 is to begin, and as described above, a user can perform an operation whereby playback will begin from the point designated by the marker 900.

In the case of the type 1 apparatus, when it is required to visually examine the transition from one cut to the succeeding cut, in the edited video data (e.g., the transition from the end of cut #002 to the start of cut #003, with the example of FIG. 11), it is necessary to perform playback of two entire cuts. Hence, an unnecessary amount of playback time is required. It would be possible to envisage some additional functions being added to such a video editing apparatus, to make it unnecessary to perform playback of all of such a pair of successive cuts. However addition of such a function will result in the overall video editing apparatus having a more complex configuration.

On the other hand, in the case of the type 2 apparatus, when it is required to visually examine the transition from one cut to the succeeding cut, in the edited video data, the apparatus can be operated such that playback will begin from a point near the end of a specific cut (e.g., cut #002 in FIG. 9), and that point can easily be specified by a user. However the point at which the playback is to be terminated is not specified. Hence (unless some additional function is added to the video editing apparatus, or the user terminates the playback each time the linkage position has been viewed), even when it is only required to examine the linkage position between two successive cuts, it is necessary to play back the entirety of one or more cuts which succeeds that linkage position. Hence, this is inconvenient to the user, and results in time being consumed in playback of unnecessary video data, when a linkage position is required to be repetitively viewed.

### SUMMARY OF THE INVENTION

It is an objective of the present invention to overcome the above problems of the prior art, by providing a video recording and playback apparatus, and a method of utilizing the apparatus, whereby respective linkage positions between successive cuts, established by video editing utilizing editing points, can be readily viewed and examined, with only simple operations required to be performed by a user of the apparatus, and without playback of unnecessary parts of the video data being performed.

To achieve the above objectives, the invention provides a video data recording and playback apparatus including a video data storage section which holds data expressing a plurality of cuts that constitute a set of edited video data, and data expressing a plurality of thumbnails respectively corresponding to the cuts, with the apparatus also including a display section, and a control section operable for controlling the video data storage section and the display section to selectively read out data of a specific plurality of the thumbnails as selection thumbnails and concurrently display the selection thumbnails in a sequentially arrayed configuration.

For example the selection thumbnails may be displayed as a horizontal row, with thumbnails arrayed in respective locations from the left to right sides corresponding to respective ones of a set of video cuts (of the edited video data) that are played back in succession when playback of the edited video data is performed.

Such an apparatus is characterized in that the display section is configured to display an intermediate image (i.e., a specific shape or symbol) that is located in an intermediate region between each adjacent pair of the displayed selection thumbnails. When a user selects one of these intermediate images (e.g., by utilizing a graphical user interface, as is well known) and subsequently designates that playback is to be performed, the control section performs successive playback of:

(a) a predetermined terminating portion of a first cut, that corresponds to the thumbnail which immediately precedes the selected intermediate image, within the successively arrayed selection thumbnails, and

(b) a predetermined initial portion of a second cut, that corresponds to the thumbnail which immediately succeeds the selected intermediate image.

The above is performed as a continuous playback sequence, i.e. extending from a specific point within the first cut to a specific point within the second cut. In that way, the user can easily visually examine each of the linkage positions between the successive cuts that constitute the edited video data, by using very simple operations, and without playback of unnecessary parts of the video data being performed. The editing work can thereby be substantially simplified and more rapidly performed, by comparison with the prior art.

Such a video recording and playback apparatus may be configured such that the respective lengths of the terminating portion of the first cut and the initial portion of the second cut are fixedly predetermined.

Alternatively, the apparatus may be configured such that the user can employ the control section to designate a length value (i.e., duration), whereby each of the terminating portion of the first cut and the initial portion of the second cut are set to that identical length.

As a further alternative, the apparatus may be configured such that the user can employ the control section to designate respectively different values of length for the terminating portion of the first cut and for the initial portion of the second cut.

In the latter case, the apparatus can be configured such that the control section judges whether a value for the length of the initial portion of the second cut has actually been designated, prior to the playback operation. When it is judged that no value has been set for the length of the initial portion of the second cut, then the subsequent playback operation is performed as continuous playback of the edited video data from the start of the aforementioned terminating portion of the first cut up to the end of the final cut of the edited video data, i.e., with each of the cuts of the edited video data that follow the selected linkage position being successively played back.

### BRIEF DESCRIPTION OF THE DRAWINGS

FIG. 1 is a general system block diagram of an embodiment of a video recording and playback apparatus;

FIG. 2 is a diagram conceptually illustrating a selection display picture generated by an editing display section of the embodiment, showing a condition in which one of a plurality of horizontally arrayed selection thumbnails has been selected;

FIG. 3 is a diagram corresponding to FIG. 2, showing a condition in which one of a plurality of intermediate images has been selected;

FIGS. 4 and 5 are diagrams respectively corresponding to FIGS. 2 and 3, but in which the selection thumbnails and intermediate images are arrayed vertically;

FIG. 6 illustrates a selection display picture generated by the editing display section of the embodiment, enabling selection of one of a plurality of different patterns for playback of video data that express a specified linkage position between successive cuts;

FIG. 7 is a flow diagram of processing executed by a control section of the embodiment for playback of video data that express a specified linkage position between successive cuts or express one or more specified successive cuts;

FIG. 8 is a diagram for describing how editing points are displayed for respective cuts in the form of text, with a prior art example of a video recording and playback apparatus;

FIG. 9 is a diagram for describing how regions containing thumbnails representing respective cuts are displayed in relation to a playback timeline in conjunction with a settable marker which determines a playback start point, with another prior art example of a video recording and playback apparatus; and

FIGS. 10, 11 are diagrams for describing how respective cuts whose editing points are expressed by text are selectively designated for successive playback.

### DESCRIPTION OF PREFERRED EMBODIMENTS

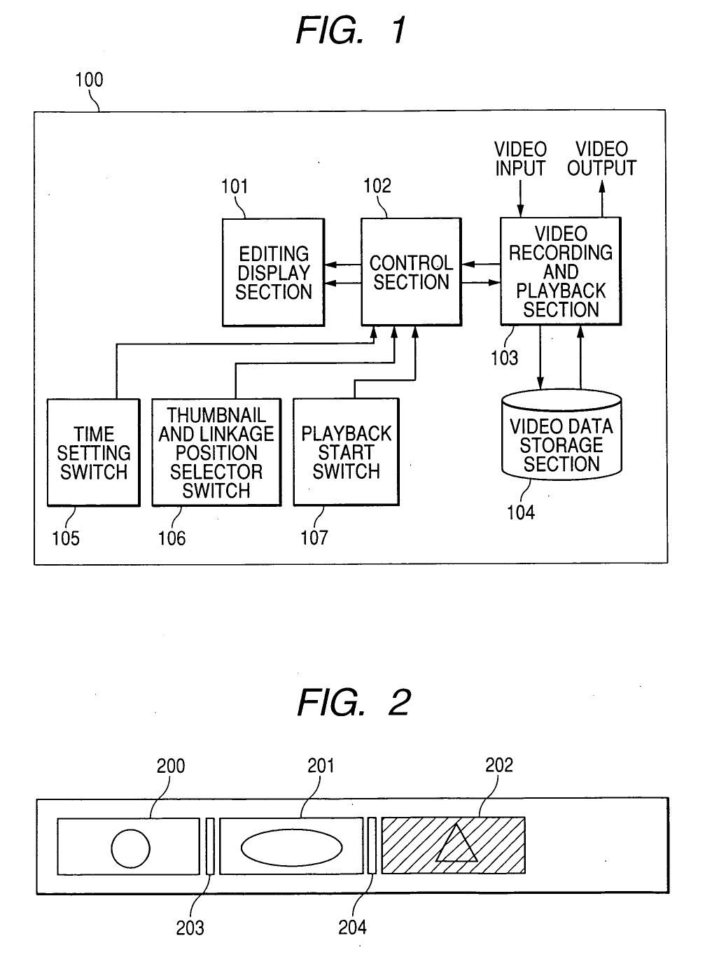

FIG. 1 is a general system block diagram of an embodiment of a video recording and playback apparatus 100. As shown, the apparatus is made up of an editing display section 101, a control section 102, a video recording and playback section 103, a video data storage section 104, a time setting switch 105, a thumbnail and linkage position selector switch 106 and a playback start switch 107. The video recording and playback section 103 can be coupled to receive an externally supplied video signal, and stores the signal contents as video data in the video data storage section 104. These video data can be processed into edited video data by the control section 102 functioning in conjunction with the editing display section 101 and the video recording and playback section 103, as designated by a user who operates the thumbnail and linkage position selector switch 106 and playback start switch 107. The video recording and playback section 103 can subsequently read out the edited video data from the video data storage section 104, under the control of the control section 102, and convert these to a corresponding video signal, which is outputted from the video recording and playback section 103.

In the following description, the term “edited video data” can signify video data expressing a plurality of video cuts that are in the process of being edited, or for which editing has been completed.

The edited video data are generated by the control section 102 under the control of the user, with specific parts of the stored video data (corresponding to respective segments of the original video signal) being selected to be used as cuts, and with the selected cuts being successively linked by specifying editing points, as described hereinabove, so that a playback order for the cuts is determined.

It should be noted that although this embodiment will be described on the assumption that the editing display section 101 is an internal part of the video recording and playback apparatus 100, it would be equally possible to utilize an external display apparatus to perform the function of the editing display section.

Each cut that is selected to be inserted in the sequence of the edited video data is predetermined as being associated with a corresponding picture unit, (e.g., selected beforehand by the user from among the stored video data of that cut) for use as a thumbnail representing a part of the contents of that cut.

The user can operate the thumbnail and linkage position selector switch 106 to input commands whereby the editing display section 101 is controlled by the control section 102 to display a set of thumbnails (referred to in the following as selection thumbnails) respectively corresponding to a series of cuts that will be successively reproduced during playback of the final edited video data. The data of the selection thumbnails are read out from the video data storage section 104 by the video recording and playback section 103 under the control of the control section 102, and thereby supplied to the editing display section 101. The cuts corresponding to the displayed selection thumbnails may constitute all of the edited video data, or may constitute a selected sequence of cuts from the edited video data.

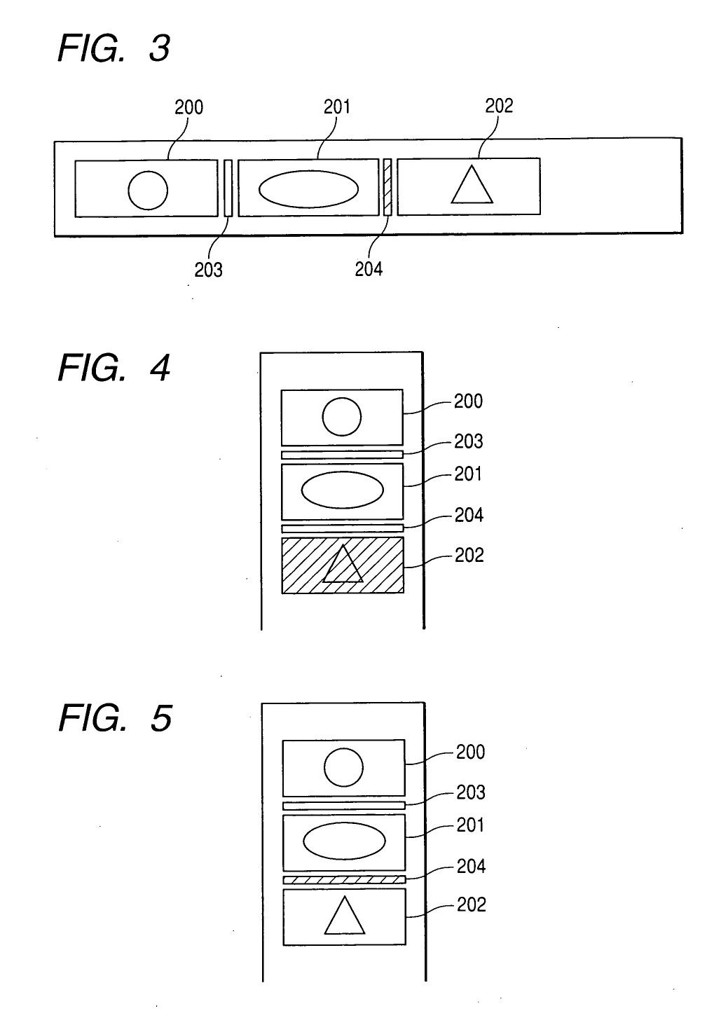

The selection thumbnails may be displayed arrayed successively horizontally as shown in FIGS. 2 and 3, however it would be equally possible for these to be displayed successively vertically, as shown in FIGS. 3 and 4.

It is a basic feature of this embodiment that the editing display section 101 displays specific defined regions between each adjacent pair of selection thumbnails. These specific regions will be referred to as the intermediate images, two of which are shown in FIGS. 2 to 5, respectively designated by numerals 203, 204.

The user can operate the thumbnail and linkage position selector switch 106 to select a specific one of the selection thumbnails, while observing these displayed by the editing display section 101. FIG. 2 illustrates the case in which the thumbnail 202 has been selected in that way from among the selection thumbnails 200, 201, 202. As described hereinafter, such a selection operation can be used to designate that playback of the cut corresponding to the selected thumbnail is to be subsequently performed, when the user actuates the playback start switch 107, or to designate that playback of the cut corresponding to the selected thumbnail and each of the succeeding cuts of the edited video data is to be subsequently performed, when the user actuates the playback start switch 107.

Alternatively, the user can operate the thumbnail and linkage position selector switch 106 to select one of the intermediate images that are displayed by the editing display section 101, as illustrated in FIG. 3 in which the intermediate image 204 has been selected.

The corresponding selection display pictures, for the case in which the selection thumbnails are arrayed vertically, are shown in FIGS. 4 and 5, i.e., respectively corresponding to FIGS. 2 and 3.

The processing whereby cuts or linkage positions between cuts of the edited video data are played back in response to operations of the thumbnail and linkage position selector switch 106 and playback start switch 107 will be described in the following. With the example of FIG. 3, the thumbnail and linkage position selector switch 106 has been operated by the user to select the intermediate image 204, i.e., the intermediate image that is located between the selection thumbnails 201, 202. In that case, when the user then actuates the playback start switch 107, the control section 102 effects control whereby playback of a predetermined final portion of the cut corresponding to the selection thumbnail 201, and playback of a predetermined initial portion of the cut corresponding to the selection thumbnail 202, are performed in succession, as a continuous playback sequence. The user is thereby enabled to view and examine the linkage position between the two successive cuts that respectively correspond to the selection thumbnails 201, 202, i.e., which respectively precede and succeed the linkage position that has been specified by selecting the intermediate image 204.

As described hereinafter, a plurality of methods of performing such playback of a linkage position can be selected by the user. With one method, the control section 102 effect control whereby a fixed-duration terminating portion of a first cut (corresponding to the selection thumbnail 201) is first played back, immediately followed by a fixed-duration initial portion of the second cut (corresponding to the thumbnail 202), as a continuous playback sequence.

The user can thereby easily examine the linkage position between the successive cuts that correspond to the selection thumbnails 201, 202.

If the user operates the thumbnail and linkage position selector switch 106 to select one of the selection thumbnails, such as the thumbnail 202 in the example of FIG. 2, then when the user subsequently actuates the playback start switch 107, the control section 102 effects control whereby the cut corresponding to that thumbnail 202 is played back and displayed by the editing display section 101.

Alternatively, it is possible to configure the apparatus such that when a selection thumbnail is selected and the playback start switch 107 is then actuated, the cut corresponding to the selected thumbnail and each of the cuts in the edited video data which succeed the cut corresponding to the selected thumbnail, are played back in continuous succession.

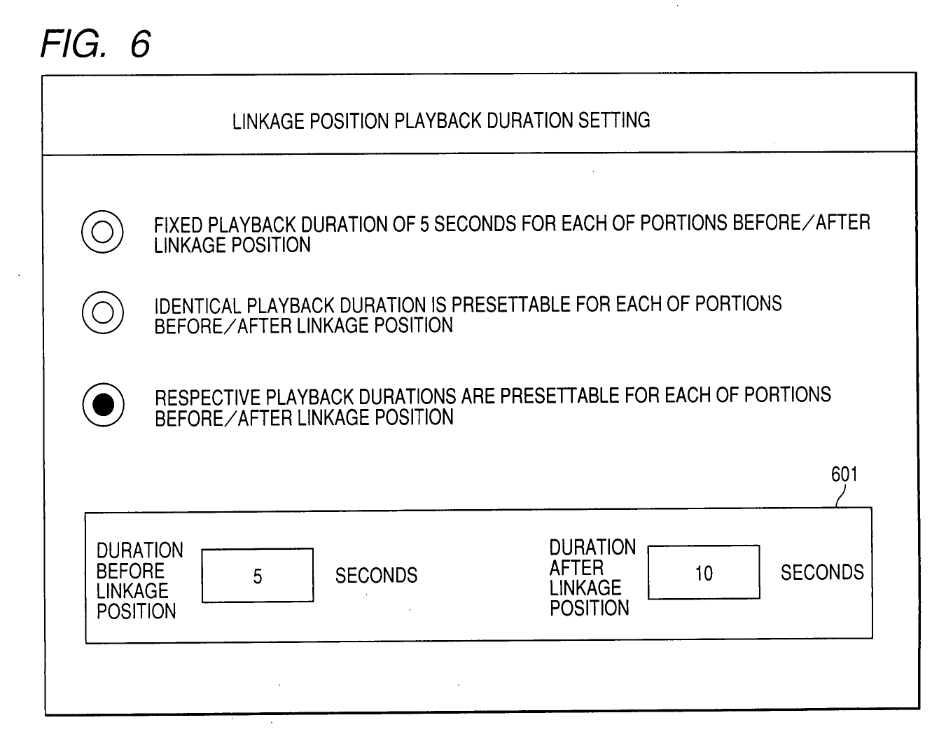

With this embodiment, a plurality of methods of performing playback for viewing linkage positions between cuts in the edited video data are available to the user (with each linkage position being indicated by a displayed intermediate image as described above). The specific method (referred to in the following as a “pattern”) is selected by the user through use of a GUI (Graphical User Interface) while viewing a selection display picture of the form shown in FIG. 6, generated by the editing display section 101. As shown, this display picture has three “radio buttons”, enabling the user to select one of three possible patterns through the GUI, i.e., by actuating a mouse switch or a keyboard key as is well known. When a pattern is selected, it is indicated by a central portion of the corresponding “radio button” being checked, as illustrated in FIG. 6 for the third pattern.

With the first of these three possible patterns, a fixed-duration portion of the first cut which precede a selected linkage position (e.g., the cut corresponding to the selection thumbnail 201 in the example of FIG. 3) is first played back, immediately followed by playback of a fixed-duration portion of the second of these two cuts (e.g., the cut corresponding to the selection thumbnail 202 in FIG. 3), with the respective durations of the terminating portion of the first cut and the initial portion of the second cut being identical. With the example of FIG. 6, each fixed duration is 5 seconds. In that case, each time the user actuates the playback start switch 107, continuous playback will occur for a duration of 10 seconds, with a terminating portion of the cut that precedes the linkage position being played during the first 5 seconds and an initial portion of the cut that succeeds the linkage position being played during the final 5 seconds

With the second of the three patterns shown in FIG. 6, the user can actuate the time setting switch 105 to set a desired duration, whose value appears within a region 601 of the selection display picture, as illustrated in FIG. 6. In this case the respective durations of the terminating portion of the first cut and the initial portion of the second cut are each set to the value that is specified by the user.

With the third of the three patterns shown in FIG. 6, the user can actuate the time setting switch 105 to set respective desired durations (i.e., mutually different values, or identical values) for the terminating portion of the cut that precedes the linkage position and the initial portion of the cut that succeeds the linkage position. The two duration values that are set by the user are respectively displayed within the region 601 of the selection display picture as illustrated in FIG. 6.

It should be noted that the invention is not limited to the three patterns described above referring to FIG. 6. For example, it would be possible for the duration of the terminating portion of the cut that precedes a linkage position to be fixedly predetermined or to be set by the user, and to configure the apparatus such that when no duration value is set for the cut that succeeds the linkage position, then playback of all of that succeeding cut will be performed immediately following playback of the terminating portion of the cut that precedes the linkage position. In that case, the apparatus can be configured such that the user is enabled to halt playback of that succeeding cut at any arbitrary point.

As a further alternative, it would be possible for the duration of the terminating portion of the cut that precedes a linkage position to be fixedly predetermined or to be set by the user, and to configure the apparatus such that when no duration value is set for the cut that succeeds the linkage position, then playback of all of the cuts which succeed the linkage position (in the predetermined playback order) is started immediately following playback of the terminating portion of the cut that precedes the linkage position, with playback being continued until the final cut, i.e., to the end of the edited video data. In that case it would be possible to provide additional regions defined within the region 601 of FIG. 6, which could be utilized by the user through the GUI to designate that such operation is to be performed, and to enable the user to designate a point (or a specific cut) at which the playback of successive cuts is to be terminated.

It should also be noted that it would be possible to provide two respectively different control sections rather than the single control section 102, i.e., a first control section for controlling the displaying and selection of thumbnails and intermediate images, and a second control section (a playback control section) for controlling playback of the cuts.

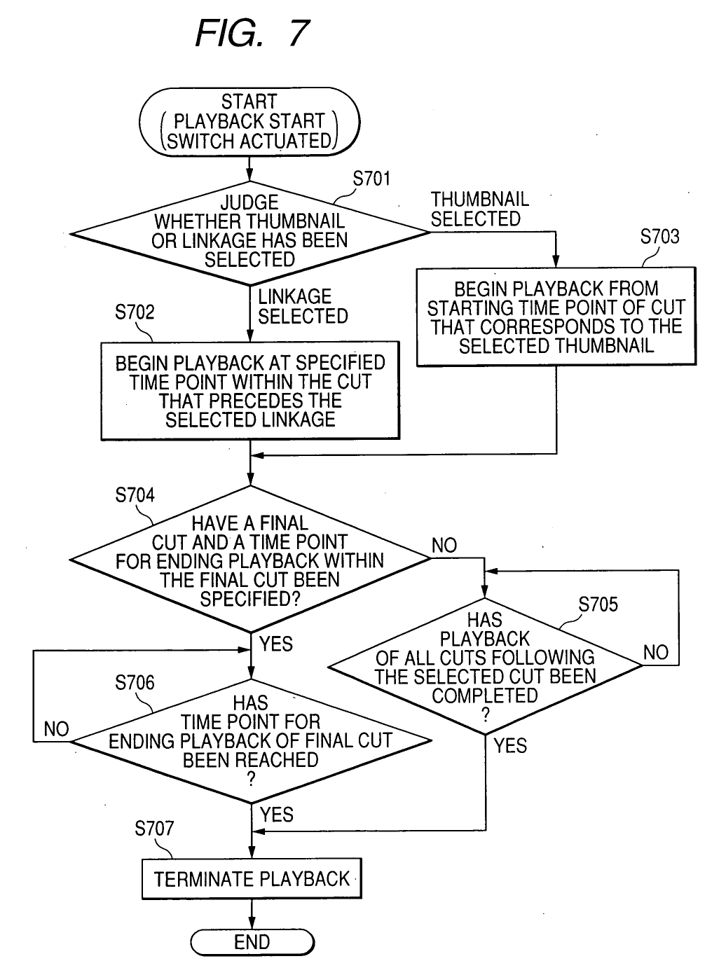

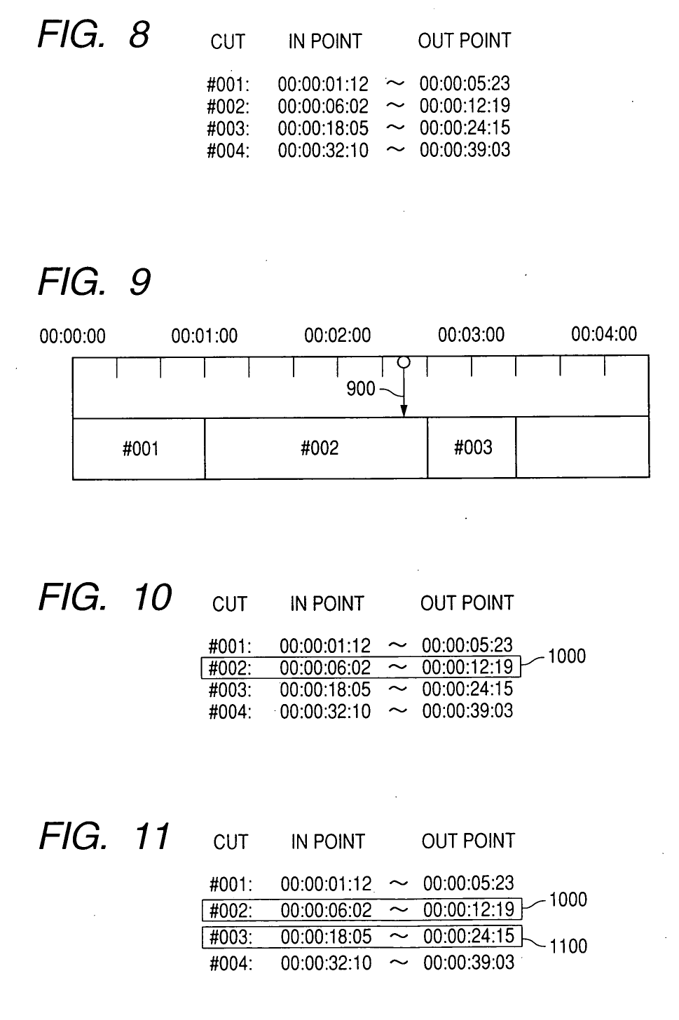

The processing executed by the control section 102 of this embodiment, when a intermediate image or a selection thumbnail is selected by the user and the playback start switch 107 is then actuated, will be described referring to the flow diagram of FIG. 7. This description assumes that the apparatus operates such when a intermediate image is selected, and no duration value is specified for the leading portion of the cut that succeeds the linkage position, or when a selection thumbnail has been selected but no final cut has been specified, then all of the cuts of the edited video data are played in succession following playback of the terminating portion of the cut that precedes the selected linkage position, or playback of the cut corresponding to the selected thumbnail.

In FIG. 7, after the user has operated to the thumbnail and linkage position selector switch 106 to select one of the selection thumbnails or to select a intermediate image as described hereinabove, and has then actuated the playback start switch 107, firstly a decision is made by the control section 102 as to whether a selection thumbnail (referred to in the following simply as a thumbnail) or an intermediate image has been selected (step S701). If a intermediate image has been selected, then playback of the cut which precedes the corresponding linkage position (step S702) is started, with the playback being initiated at a point within that preceding cut which is determined in accordance with the duration value set for the final portion of that preceding cut, as described hereinabove referring to FIG. 6. For example if 5 seconds has been specified, then playback begins at a point which occurs 5 seconds before the end of that preceding cut.

A decision is then made (step S704) as to whether both of the conditions are satisfied that:

(a) a final cut (i.e., in which the playback is to be terminated) has been specified, and

(b) the point of termination of playback of that final cut has been specified (i.e., duration of the initial portion, as described hereinabove referring to FIG. 6).

If a intermediate image has been selected, then the “final cut” is automatically determined as the cut which succeeds the linkage position.

If it is found that these conditions are satisfied, then step S706 is executed while otherwise, step S705 is executed. In step S706, playback is continued until the specified point of termination of playback of the final cut is judged to have been reached (i.e., in the case of a linkage position having been selected, playback of the specified-duration initial portion of the cut that succeeds the selected linkage position has been completed). Playback is then ended (step S707).

In step S705, playback of each of the successive cuts constituting the edited video data is performed until it is judged that playback of the final cut of the edited video data has been completed, and playback is then terminated in step S707.

If on the other hand it is judged in step S701 that one of the selection thumbnails has been selected by the user, then playback of the cut corresponding to the selected thumbnail is started (step S703). A decision is then made as to whether the above-described conditions of step S704 are satisfied. In this case, if the conditions of step S704 are not satisfied (as will be the case if a final cut has not been specified), then step S705 is executed as described above to continue playback of all of the cuts of the edited video data in succession, and playback is then terminated in step S707.

As can be understood from the above, the present invention enables video editing work to be substantially simplified, since a user can readily specify a linkage position between two successive cuts within the edited video data, and thereby initiate playback of a portion of the edited video data that extends from a specific point within the cut that immediately precedes the linkage position up to a specific point within the cut that immediately follows the linkage position. In that way, the user can readily examine editing point information which links one cut to a succeeding cut, while eliminating the need to perform playback of unnecessary portions of the edited video data in order to perform such examination. Hence, the editing work can not only be simplified but can also be performed more speedily.

Such a video recording and playback apparatus can directly utilize the contents of a playlist, and enables a user to examine the effects of editing (i.e., modification of the playlist) by operations that are substantially identical to those used to control playback of the edited results.

It should be understood that the invention is not limited to the embodiment described above and that various modifications or alternative configurations could be envisaged, which fall within the scope claimed for the invention in the appended claims.

What is claimed is:

1. A video data recording and playback apparatus comprising:
video data storage means having stored therein data expressing a plurality of video cuts that are to be subjected to video editing and have a predetermined order of playback, and data expressing a plurality of thumbnail images each representing a portion of a corresponding one of said video cuts;
display control means for deriving a video signal from said stored video data and supplying said video signal to a display section to thereby display a plurality of said stored thumbnail images, arrayed with a predetermined spacing between adjacent pairs thereof;
designation means operable for designating an intermediate region that is located between a specific adjacent pair of said displayed thumbnail images; and
playback control means responsive to said designation of said intermediate region for performing successive playback of a predetermined terminating portion of a first video cut and of a predetermined initial portion of a second video cut, as a continuous playback sequence;
wherein said first video cut and second video cut correspond to respective ones of said specific adjacent pair of displayed thumbnail images.

2. A video data recording and playback apparatus according to claim 1, wherein:
said display control means generates a display of an intermediate image in a specific region located in said intermediate region; and
said playback control means effects said continuous playback sequence in response to said intermediate image being designated.

3. A video data recording and playback apparatus according to claim 1, further comprising selector means operable for selecting data of thumbnail images to be displayed by said display section, from said data expressing said plurality of stored thumbnail images.

4. A video data recording and playback apparatus according to claim 1, wherein said playback control means is operable for designating an identical duration for each of said terminating portion of said first video cut and said initial portion of said second video cut.

5. A video data recording and playback apparatus according to claim 1, wherein said playback control means is operable for designating respectively different durations for said terminating portion of said first video cut and said initial portion of said second video cut.

6. A video data recording and playback apparatus according to claim 5, wherein said playback control means comprises means for judging whether a duration of said initial portion of said second video cut has been designated, prior to said playback operation, and for performing said playback operation as continuous playback from a starting point of said terminating portion of said first video cut up to an end point of a final video cut in said predetermined playback order, when it is judged that no value has been designated for said duration of said initial portion of said second video cut.

7. A video data recording and playback apparatus comprising:
video data storage means having stored therein data expressing a plurality of video cuts that are to be subjected to video editing and for which a specific order of playback has been predetermined, and data expressing a plurality of thumbnail images each representing a portion of a corresponding one of said video cuts;
display control means for deriving a video signal from said stored video data and supplying said video signal to a display section to thereby display a plurality of said stored thumbnail images successively arrayed with a fixed spacing between adjacent pairs thereof;
designation means operable for designating an intermediate region that is located between a specific adjacent pair of said displayed thumbnail images; and
playback control means responsive to said designation of said intermediate region for performing playback of a predetermined terminating portion of a first video cut and of the entirety of a second video cut and any respectively adjacent video cuts which succeed said second video cut within said predetermined playback order, as a continuous playback sequence;
wherein said first video cut and second video cut correspond to respective ones of said specific adjacent pair of displayed thumbnail images, and said first video cut immediately precedes said second video cut within said predetermined playback order.

8. A video data recording and playback apparatus according to claim 7, wherein:
said display control means generates a display of an intermediate image in a specific region located in said intermediate region; and
said playback control means effects said continuous playback sequence in response to said intermediate image being designated.

9. A video data recording and playback apparatus according to claim 7, further comprising selector means operable for selecting data of thumbnail images to be displayed by said display section, from said data expressing said plurality of stored thumbnail images.

10. A video playback method utilized in a video data recording and playback apparatus, comprising:
a display step of displaying a plurality of thumbnail images by a display section, successively arrayed with a predetermined spacing between adjacent pairs thereof, each said thumbnail image representing a portion of a corresponding one of a plurality of video cuts that are to be subjected to video editing and that have a predetermined order of playback;
a designation step of designating an intermediate region that is located between an adjacent pair of said displayed plurality of thumbnail images; and
a playback step, executed when said intermediate region is designated, of performing playback of a predetermined terminating portion of a first video cut and of a predetermined initial portion of a second video cut as a continuous playback sequence, with said first video cut and second video cut corresponding to respective ones of said specific adjacent pair of displayed thumbnail images, and with said first video cut immediately preceding said second video cut in said predetermined playback order.

11. A video playback method according to claim 10, wherein:
said display step comprises generating a display of an intermediate image in a specific region located in said intermediate region; and
said playback step is executed when said intermediate image is designated.

12. A video playback method according to claim 10 comprising a selection step, executed prior to said display step, of selecting thumbnail images to be displayed by said display section.

13. A video playback method utilized in a video data recording and playback apparatus, comprising:
a display step of displaying a plurality of thumbnail images by a display section, successively arrayed with a fixed spacing between adjacent pairs thereof, each said thumbnail image representing a portion of a corresponding one of a plurality of video cuts that are to be subjected to video editing and that have a predetermined order of playback;
a designation step of designating an intermediate region that is located between an adjacent pair of said displayed plurality of thumbnail images; and
a playback step, executed when said intermediate region is designated, of performing playback of a predetermined terminating portion of a first video cut and of the entirety of a second video cut and any respectively adjacent video cuts which succeed said second video cut within said predetermined playback order, as a continuous playback sequence, with said first video cut and second video cut corresponding to respective ones of said specific adjacent pair of displayed thumbnail images, and with said first video cut immediately preceding said second video cut within said predetermined playback order.

14. A video playback method according to claim 13, wherein:
said display step comprises generating a display of an intermediate image in a specific region located in said intermediate region; and
said playback step is executed when said intermediate image is designated.

15. A video playback method according to claim 13 comprising a selection step, executed prior to said display step, of selecting thumbnail images to be displayed by said display section.
